(19) United States
(12) Patent Application Publication
(10) Pub. No.: US 2018/0228336 A1
(43) Pub. Date: Aug. 16, 2018

(54) Device for cleaning an exercise mat

(71) Applicant: Peter J. Tornaben, Jupiter Island, FL (US)

(72) Inventor: Peter J. Tornaben, Jupiter Island, FL (US)

(21) Appl. No.: 15/932,356

(22) Filed: Feb. 16, 2018

Related U.S. Application Data
(60) Provisional application No. 62/459,910, filed on Feb. 16, 2017.

(51) Int. Cl. A47L 11/40; A63B 21/00; B05B 11/00

(52) U.S. Cl. CPC A47L 11/4044; B05B 11/3001; A63B 21/4037

(57) ABSTRACT

An exercise mat cleaning device includes a liquid dispensing container for holding a sanitizing solution, and a pump sprayer fitted to a top of the container. A longitudinal edge of the exterior wall structure of the container is fitted with a squeegee blade formed of a rubber or silicon material. A cap removably attaches to the top of the container for covering the pump sprayer. A loop is provided on the bottom of the container for attachment of a lanyard thereto to facilitate ease of carrying the device.

### BACKGROUND OF THE INVENTION

This non-provisional patent application is based on provisional patent application Ser. No. 62/459,910 filed Feb. 16, 2017.

### FIELD OF THE INVENTION

The present invention relates to surface cleaning devices and, more particularly, to a device for cleaning exercise mats, such as those used for yoga and pilates and wherein the device includes a pump spray container for dispensing a sprayed liquid sanitizing solution and a rubber/silicon squeegee fitted to an exterior vertical edge of the container.

### DISCUSSION OF THE RELATED ART

Exercise mats are used by millions of people participating in yoga, pilates and other fitness programs that involve floor exercises. A typical exercise mat used in yoga and pilates is made of a thin, flexible plastic based foam or rubber material. The exercise mat provides both a cushion on hard floor surfaces as well as a means to create friction allows the user to perform various exercise movements. During the course of a typical yoga or pilates session, a person will usually sweat as a result of the strenuous routines and physical exertion. The user's sweat is transferred to the exercise mat during the exercise session. Naturally, sweat contains germs and bacteria that will accumulate on the exercise mat. Moreover, placement of the exrcise mat on the floor surface causes the mat to pick up additional debris such as dirt, dust, hair and other contaminants, including germs and bacteria. In order to minimize exposure to these germs, bacteria and other contaminants, most participants in yoga, pilates and other exercise programs will attempt to clean their exercise mat at the end of the exercise routine with the use of a pre-moistened antibacterial wipe or a bottle sprayed sanitizing solution and a towel. However, these methods of cleaning an exercise mat are not entirely effective in removing germs, bacteria and other contaminants to properly sanitize the exercise mat.

Accordingly, there is a definite and urgent need for a compact and convenient device that effectively cleans and sanitizes the surfaces of exercise mats in a quick and efficient manner, and wherein the device is adapted to be conveniently carried to a fitness studio.

### BRIEF DESCRIPTION OF THE DRAWINGS

For a fuller understanding of the nature of the present invention, reference should be made to the following description taken in conjunction with the accompanying drawings in which:

FIG. 1 is a front, top perspective view showing the exercise mat cleaning device of the present invention;

FIGS. 2 is a bottom, side perspective view showing the exercise mat cleaning device of the present invention; and

FIG. 3 is an exploded perspective view showing the component parts of the exercise mat cleaning device including a container having a generally triangular shaped wall structure with three vertically extending edges and a pump sprayer with an elongate tube that is adapted to be fitted to a top of the container, a removable cap for covering the pump sprayer, and a rubber/silicon squeegee blade that is fitted within a vertically extending dovetail slot extending along one of the vertical edges of the container.

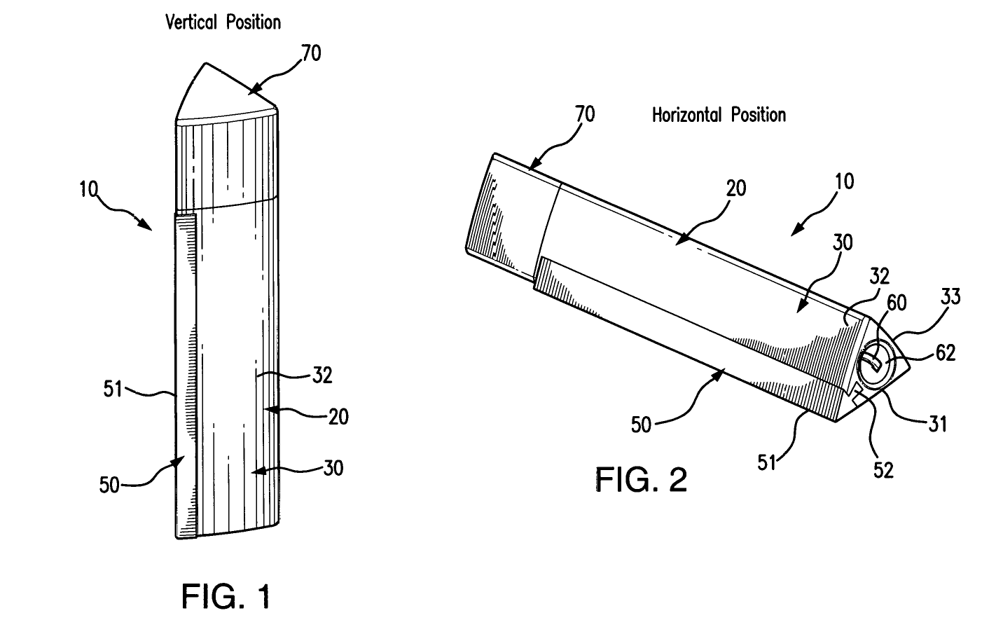

Like reference numerals refer to like parts throughout the several views of the drawings.

### DETAILED DESCRIPTION OF THE PREFERRED EMBODIMENT

Referring to the several views of the drawings, the exercise mat cleaning device of the present invention is shown and is generally indicated as 10. The device 10 includes a liquid dispensing container 20 for holding a sanitizing solution with an interior chamber. The device 10 further includes a pump sprayer 22 that has a pump spray actuator 24, an attachment collar 25 for threaded engagement onto the threaded neck 28 surrounding an open top of the container 20, and a elongate tube extending from the pump spray actuator 24 for receipt through the open top of the container 20 and into the interior liquid containment chamber of the container. The pump sprayer 22 operates in the same manner as well-known pump sprayers which draw liquid up through the open bottom end of the tube and, with each downward depression of the pump spray actuator 24, a charge of liquid is dispensed as a mist from a spray nozzle on the actuator.

The container 20 is preferably formed to have a generally triangular wall configuration 30 with three vertically extending sides, including a first side 31, a second side 32 and a rear side 33. In one embodiment, the three vertically extending sides 31, 32 and 33 are flat to allow any one of the sides 31, 32 or 33 to rest on a surface, such as a table, counter or floor surface. In one embodiment, the wall structure 30 of the container is formed of a clear polycarbonate material that reveals the level of the liquid sanitizer remaining in the container.

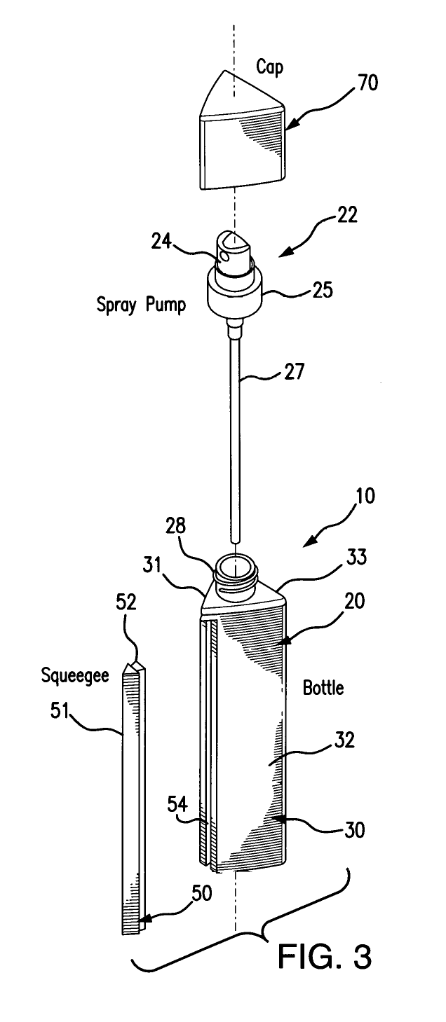

One of the vertical edges between the first front wall 31 and the second front wall 32 is formed with a longitudinal dovetail slot 54. This dovetail slot 54 is specifically sized and configured for congruent receipt of a dovetail member 52 on a squeegee 50, as seen in FIGS. 2 and 3. Specifically, the dovetail slot 54 captures the dovetail member 52 of the squeegee 50 therein to hold the squeegee on the container wall structure 30 so that the squeegee 50 forms one of the vertical side edges between the wall sections 31 and 32. In one embodiment, the squeegee is formed of a flexible and resilient material, such as a rubber composition. The leading edge 51 of the squeegee 50 serves as a blade to wipe excess fluid from a surface, such as the surface of an exercise mat. In use, sanitizing solution is sprayed from the container, with use of the pump sprayer 22 and is directed onto an exercise mat. Thereafter, the squeegee 50 is used to remove excess sanitizing solution, while spreading the solution over the entire surface of the exercise mat, as the leading edge 51 of the squeegee 50 is moved, with slight pressure, against the surface of the exercise mat. This allows the entire surface of the exercise mat to be quickly and effectively sanitized.

A cap 70 is removably attachable to the top of the container 20 to cover the pump sprayer 22 when the device is not in use. For convenience in carrying the exercise mat cleaning device 10, a loop 60 is provided within a recessed area 62 on the bottom of the container 20 for attachment of a lanyard which can form a handle to allow the device 10 to be easily carried and transported to and from an exercise/fitness studio.

While the present invention has been shown and described in accordance with a preferred and practical embodiment, it is recognized that departures from the instant disclosure are fully contemplated within the spirit and scope of the present invention which is not to be limited, except as defined in the following claims as interpreted under the Doctrine of Equivalents.

What is claimed is:

1. A device for cleaning a surface with a liquid solution, the device comprising:
a container including a bottom, a top, a vertical wall structure extending from the bottom to the top, and an interior chamber for holding the liquid solution;
a sprayer on the container and including a spray actuator and nozzle, and the sprayer communicating with the liquid solution in the interior chamber, and the spray actuator being operable to cause discharge of the liquid solution out from the nozzle; and
a squeegee blade on the vertical wall structure and protruding outwardly from an exterior of the vertical wall structure, and the squeegee blade being structured and disposed for spreading the liquid solution over the surface being cleaned and removing an excess amount of the liquid solution from the surface.

2. The device as recited in claim 1 wherein the vertical wall structure includes at least two side faces and a vertically extending juncture between the at least two side faces.

3. The device as recited in claim 2 wherein the squeegee blade extends at least partially along a length of the vertically extending juncture.

4. The device as recited in claim 3 wherein the squeegee blade is formed of a flexible and resilient material.

5. The device as recited in claim 4 wherein the squeegee blade includes at least one attachment member thereon and the vertical wall structure includes a congruently configured slot extending at least partially along the length of the vertically extending juncture for fitted, attached receipt of the at least one attachment member therein, to thereby attach the squeegee blade to the vertical wall structure of the container.

6. The device as recited in claim 5 wherein the attachment member is a dovetail shaped member and the slot is a dovetail slot for congruent and attached receipt of the dovetail shaped member therein.

7. The device as recited in claim 6 wherein the sprayer is a pump sprayer and the spray actuator is a pump spray actuator.

8. The device as recited in claim 7 further comprising a loop member on the bottom of the container for attachment of a lanyard thereto.

9. The device as recited in claim 8 wherein the bottom of the container includes a recessed area and the loop member is entirely within the recessed area.

10. The device as recited in claim 9 wherein the vertical wall structure includes three side faces including a first side face, a second side face and a third side face, and further wherein the three side faces are each flat.

11. A device for cleaning a surface with a liquid solution, the device comprising:
a container including a bottom, a top, a vertical wall structure extending from the bottom to the top, and an interior chamber for holding the liquid solution, and the vertical wall structure including at least two side faces and a vertically extending juncture between the at least two side faces;
a sprayer on the container and including a spray actuator and nozzle, and the sprayer communicating with the liquid solution in the interior chamber, and the spray actuator being operable to cause discharge of the liquid solution out from the nozzle; and
a squeegee blade on the vertical wall structure and protruding outwardly from an exterior of the vertical wall structure and extending at least partially along a length of the vertically extending juncture, and the squeegee blade being structured and disposed for spreading the liquid solution over the surface being cleaned and removing an excess amount of the liquid solution from the surface.

12. The device as recited in claim 11 wherein the squeegee blade is formed of a flexible and resilient material.

13. The device as recited in claim 12 wherein the squeegee blade includes at least one attachment member thereon and the vertical wall structure includes a congruently configured slot extending at least partially along the length of the vertically extending juncture for fitted, attached receipt of the at least one attachment member therein, to thereby attach the squeegee blade to the vertical wall structure of the container.

14. The device as recited in claim 13 wherein the attachment member is a dovetail shaped member and the slot is a dovetail slot for congruent and attached receipt of the dovetail shaped member therein.

15. The device as recited in claim 14 wherein the sprayer is a pump sprayer and the spray actuator is a pump spray actuator.

16. The device as recited in claim 15 further comprising a loop member on the bottom of the container for attachment of a lanyard thereto.

17. The device as recited in claim 16 wherein the bottom of the container includes a recessed area and the loop member is entirely within the recessed area.

18. The device as recited in claim 17 wherein the vertical wall structure includes three side faces including a first side face, a second side face and a third side face, and further wherein the three side faces are each flat.
